(19) United States
(12) Patent Application Publication
(10) Pub. No.: US 2024/0397386 A1
(43) Pub. Date: Nov. 28, 2024

(54) COMMUNICATION SYSTEMS, CONTROL METHODS, CONTROLLERS, AND PROGRAMS

(71) Applicant: NIPPON TELEGRAPH AND TELEPHONE CORPORATION, Tokyo (JP)

(72) Inventors: Yuki SAKAUE, Musashino-shi, Tokyo (JP); Tomohiro TANIGUCHI, Musashino-shi, Tokyo (JP)

(73) Assignee: NIPPON TELEGRAPH AND TELEPHONE CORPORATION, Tokyo (JP)

(21) Appl. No.: 18/691,005

(22) PCT Filed: Sep. 16, 2021
(86) PCT No.: PCT/JP2021/034076

§ 371 Date: Mar. 11, 2024

(51) Int. Cl. H04W 28/18; H04W 28/02; H04W 72/1273; H04W 72/54

(52) U.S. Cl. CPC H04W 28/18; H04W 28/0278; H04W 72/1273; H04W 72/54

(57) ABSTRACT

The present invention aims to provide a communication system, a control method, a controller, and a program capable of preventing deterioration in communication quality due to wireless control signals for quality control.

In a communication system according to the present invention, each of a terminal and an access point transmits an accumulated packet amount notification that is an amount of packets accumulated in a buffer having the same content a plurality of times when transmitting the accumulated packet amount notification to the controller as the control signal, and the controller determines a schedule for transmitting the packet based on the content of the accumulated packet amount notification received from at least one of the terminal and the access point, and transmits the schedule having the same content a plurality of times when the schedule is transmitted to each of the terminal and the access point as the control signal.

### TECHNICAL FIELD

The present disclosure relates to a communication system, a control method, a controller, and a program for wirelessly transmitting and receiving a control signal.

### BACKGROUND ART

In recent years, there have been studies on accommodating a plurality of services and applications having various network requirements on the same network infrastructure. For this purpose, it is necessary to ensure the quality required by each service and application accommodated on the same NW in an end-end section of “terminal to terminal” or “terminal to application server”.

The end-end sections of a network can be divided into wireless and wired sections. Among those, in wireless sections, there is a priority control function called Enhanced Distributed Channel Access (EDCA) of IEEE 802.11 as an existing technology (see, for example, Non Patent Literature 1 and Non Patent Literature 2).

EDCA is control on a terminal (destination) basis, and while it is difficult to perform control on a traffic flow basis to enable quality control on a service and application basis, quality control on a service and application basis can be realized by applying a quality control technology (see, for example, Non Patent Literature 3) by centralized control independent of a wireless network.

### CITATION LIST

### Non Patent Literature

Non Patent Literature 1: IEEE 802.11e-2005—IEEE Standard for Information technology—Local and metropolitan area networks—Specific requirements—Part 11: Wireless LAN Medium Access Control (MAC) and Physical Layer (PHY) Specifications—Amendment 8: Medium Access Control (MAC) Quality of Service Enhancements
Non Patent Literature 2: “QOS o jitsugen suru musen ran kikaku IEEE 802.11e (in Japanese) (IEEE802.11e—Wireless LAN Standard for implementing QOS)”, The journal of the Institute of Image Information and Television Engineers Vol. 57, No. 11 (2003)
Non Patent Literature 3: “Musen NW ni izon shinai shūchū seigyo ni yoru hinshitsu seigyo gijutsu no teian (in Japanese) (Proposed quality control technology by centralized control not depending on wireless NW)”, The Institute of Electronics, General Conference of Information and Communication Engineers (IEICE) B-6-5(2021)

### SUMMARY OF INVENTION

### Technical Problem

FIG. 1 to FIG. 4 are diagrams describing problems of the present invention. As illustrated in FIG. 1, by making a control signal for quality control wireless, a restriction on a wired cable is eliminated similarly to main signal communication, and situations to which EDCA can be applied increase. FIG. 2 is a sequence diagram for explaining exchange of a corresponding control signal. There is a period Tc in which the controller performs scheduling and periods t in which the terminal or the access point gives a notification of the amount of packets accumulated in its own buffer. FIG. 2 illustrates a case of Tc=5t.

The terminal #N transmits the packet amount b newly accumulated in the buffer #M held by the terminal #N to the controller as an accumulated packet amount notification I in each time t. Specifically, the terminal #N transmits information indicating that the packet amount accumulated in the buffer #M is zero in accumulated packet amount notification I₀ (there is no packet in the buffer until transmission of I₁), the packet amount is 1 in accumulated packet amount notification I₁ (one packet b is accumulated in the buffer #M at a cycle t₁), the packet amount is 3 in accumulated packet amount notification I₂ (two packets b are accumulated in buffer #M at a cycle t₂), the packet amount is 4 in accumulated packet amount notification I₃ (one packet b is accumulated in buffer #M at a cycle t₃), and the packet amount is 5 in accumulated packet amount notification I₄ (one packet b is accumulated in buffer #M at a cycle t₄).

Thereafter, the terminal #N repeats the above operation at the cycles t₁.

The controller integrates the accumulated packet amount notification I that has arrived in period Tc, and recognizes that five packets are accumulated in the buffer #M of the terminal #N. Then, the controller schedules the transmission timing and the transmission time for five packets for the buffer #M of the terminal #N. The controller transmits a schedule Sc to the terminal #N. Further, the transmission timing is “a timing to start packet transmission”, and the transmission time is “a temporal length in which packet transmission is permitted”.

The terminal #N transmits five packets from the buffer #M to the access point #K at the timing indicated by the schedule Sc at the indicated speed (step Bt).

Further, although FIG. 2 is a sequence diagram for when a packet is transmitted from the terminal to the access point, the same applies when a packet is transmitted from the access point to the terminal.

On the other hand, in a case where the control signal is made wireless, the occurrence of packet loss due to an external factor increases more than in a case where the control signal is made wired, and there is a possibility of an event like that illustrated in FIG. 3 and FIG. 4 occurring and appropriate scheduling not being performed.

FIG. 3 is a sequence diagram illustrating a problem that occurs when a part of an accumulated packet amount notification I is not delivered. Since the accumulated packet amount notification I₄ is not delivered, the controller erroneously recognizes that four packets are accumulated in the buffer #M of the terminal #N. Then, the controller schedules the transmission timing and the transmission time for four packets for the buffer #M of the terminal #N. Therefore, the terminal #N can transmit only four packets from the buffer #M, and the communication quality deteriorates.

FIG. 4 is a sequence diagram for explaining a problem that occurs due to the schedule Sc not being delivered. It is assumed that the controller transmits the schedule Sc for transmitting five packets from the buffer #M to the terminal #N, but the terminal #N is not able to receive the schedule Sc. Then, the terminal #N cannot transmit the packets, and the communication quality deteriorates.

That is, situations to which EDCA can be applied increase when a control signal for quality control is made wireless, but there is a problem that communication quality may deteriorate due to packet loss of the control signal.

Therefore, in order to solve the above problems, it is an object of the present invention to provide a communication system, a control method, a controller, and a program capable of preventing deterioration in communication quality due to wireless control signals for quality control.

### Solution to Problem

In order to achieve the above object, the communication system according to the present invention transmits the same control signal a plurality of times.

Specifically, a communication system according to the present invention is a communication system that controls traffic of a wireless network, the communication system including a terminal and an access point that transmit a packet to each other via the wireless network, and a controller that transmits and receives a control signal to and from the terminal and the access point via the wireless network, in which each of the terminal and the access point transmits an accumulated packet amount notification that is an amount of packets accumulated in a buffer having the same content a plurality of times when the accumulated packet amount notification is transmitted to the controller as the control signal, and the controller determines a schedule for transmitting the packet based on the content of the accumulated packet amount notification received from at least one of the terminal and the access point and transmits the schedule having the same content a plurality of times when the schedule is transmitted to each of the terminal and the access point as the control signal.

In addition, a control method according to the present invention is a control method for controlling traffic of a wireless network including a terminal and an access point that transmit a packet to each other via the wireless network and a controller that transmits and receives a control signal to and from the terminal and the access point via the wireless network, the control method including transmitting, by each of the terminal and the access point, an accumulated packet amount notification that is an amount of packets accumulated in a buffer having the same content a plurality of times when the accumulated packet amount notification is transmitted to the controller as the control signal, and determining, by the controller, a schedule for transmitting the packet based on the content of the accumulated packet amount notification received from at least one of the terminal and the access point and transmitting the schedule having the same content a plurality of times when the schedule is transmitted to the terminal and the access point as the control signal.

Furthermore, a controller according to the present invention is a controller that transmits and receives a control signal to and from a terminal and an access point via a wireless network, the terminal and the access point transmitting a packet to each other via the wireless network, the controller including a reception unit that receives, as the control signal, an accumulated packet amount notification that is an amount of packets accumulated in each buffer from at least one of the terminal and the access point, a scheduling unit that determines a schedule for transmitting the packet based on the content of the accumulated packet amount notification, and a transmission unit that transmits the schedule having the same content a plurality of times when the schedule is transmitted to each of the terminal and the access point as the control signal.

Since the transmission side transmits the control information (the accumulated packet amount notification and the schedule) having the same content a plurality of times, even if packet loss occurs during transmission, the reception side can receive any one piece of the control information transmitted a plurality of times. Thus, the present invention can provide a communication system, a control method, a controller, and a program capable of preventing deterioration in communication quality due to wireless control signals for quality control.

The load of reading all control information transmitted a plurality of times on the reception side is heavy. Thus, it is preferable that a sequence number be assigned to the accumulated packet amount notification and the schedule, the controller discard the accumulated packet amount notification whose sequence number is the same as that of the previous accumulated packet amount notification, and the terminal and the access point discard the schedule whose sequence number is the same as that of the previous schedule.

The present invention is a program for causing a computer to function as the controller. A data collection device of the present invention can also be implemented by a computer and a program, and the program can be recorded in a recording medium or provided through a network.

Further, the above inventions can be combined where possible.

### Advantageous Effects of Invention

The present invention can provide a communication system, a control method, a controller, and a program capable of preventing deterioration in communication quality due to wireless control signals for quality control.

### BRIEF DESCRIPTION OF DRAWINGS

FIG. 1 is a diagram describing a problem of the present invention.

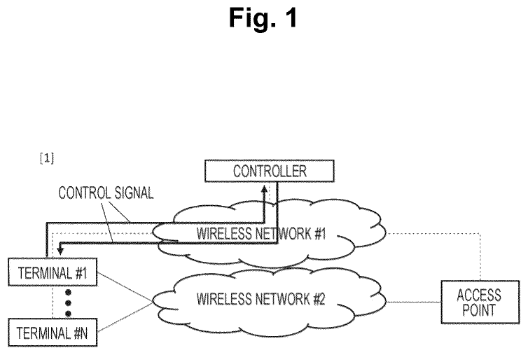

FIG. 2 is a sequence diagram describing a problem of the present invention.

FIG. 3 is a sequence diagram describing a problem of the present invention.

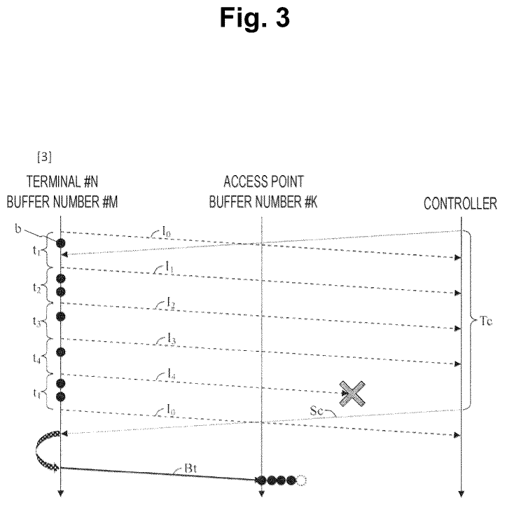

FIG. 4 is a sequence diagram describing a problem of the present invention.

FIG. 5 is a diagram for describing a communication system according to the present invention.

FIG. 6 is a diagram for describing a database included in a controller according to the present invention.

FIG. 7 is a diagram for describing an operation of the communication system according to the present invention.

FIG. 8 is a sequence diagram describing an effect of the present invention.

FIG. 9 is a sequence diagram describing an effect of the present invention.

FIG. 10 is a diagram for describing an operation of the communication system according to the present invention.

FIG. 11 is a diagram for describing the communication system according to the present invention.

### DESCRIPTION OF EMBODIMENTS

Embodiments of the present invention will be described with reference to the accompanying drawings. The embodiments described below are examples of the present invention, and the present invention is not limited to the following embodiments. Further, components having the same reference numerals in the present specification and the drawings indicate the same components.

### First Embodiment

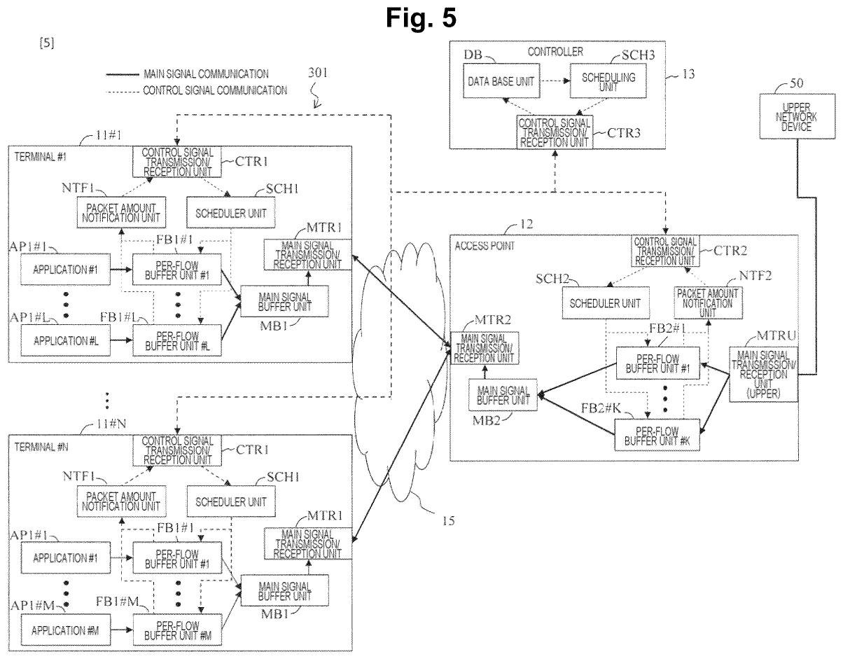

FIG. 5 is a diagram for describing a communication system 301 of the present embodiment. The communication system 301 is a control system that controls traffic of a wireless network 15 #2, and includes a terminal 11 and an access point 12 that mutually transmit packets to each other via the wireless network 15 #2, and a controller 13 that performs transmission control over the terminal 11 and the access point 12, in which the controller 13 determines a schedule (a transmission timing and a transmission amount for each traffic flow) at least based on a packet amount stored in a buffer notified of by the terminal 11 (which is a packet amount stored in each of buffers in the case of FIG. 5, the buffers provided for each traffic flow), and notifies the terminal 11 and the access point 12 of the schedule.

Since the controller 13 calculates a schedule for each traffic flow by using control information of each traffic flow (see, for example, Non Patent Literature 3), the communications system 301 can ensure a band for each traffic flow.

Further, the communication system 301 in FIG. 5 includes the wireless network 15 #2 that transmits a main signal and the wireless network 15 #1 that transmits control information (accumulated packet amount notifications and schedules), but the main signal and the control information may be transmitted through one wireless network.

The communication system 301 connects each terminal 11 and an access point 12 to the controller 13, and performs accumulating packets in buffer units (FB1 and FB2) for each traffic flow in each terminal 11 and the access point 12 or in a buffer in an application, notifying the controller 13 of the accumulated packet amount in advance, determining a transmission timing and a transmission amount for each traffic flow in a scheduling unit SCH3 of the controller 13, causing the controller 13 to notify each terminal 11 and the access point 12 of a schedule (the transmission timing and the transmission amount) a plurality of times, and transmitting packets according to the transmission timing and the transmission amount of which each terminal 11 and the access point 12 are notified.

Further, timings of each terminal 11, the access point 12, and the controller 13 are assumed to be synchronized using NTP, PTP, or the like.

Specifically, the communication system 301 is a communication system that controls traffic of the wireless network 15, and includes the terminals 11 and the access point 12 that mutually transmit packets via the wireless network 15 #2, and the controller 13 that transmits and receives a control signal to and from the terminals 11 and the access point 12 via a wireless network 15 #1, in which each of the terminals 11 and the access point 12 transmit an accumulated packet amount notification, which is of a packet amount accumulated in the buffer units (FB1 and FB2) having the same content a plurality of times when transmitting the accumulated packet amount notification to the controller 13 as the control signal, and the controller 13 determines a schedule for transmitting the packets based on the content of the accumulated packet amount notification received from at least one of the terminal 11 and the access point 12, and transmits the schedule having the same content a plurality of times when transmitting the schedule as the control signal to each of the terminals 11 and the access point 12.

The communication system 301 communicates a control signal between the controller 13 and the access point 12/terminals 11 using a communication means (wireless network 15 #1) that is different from a communication means (wireless network 15 #2) for the main signal (packets in traffic). Specifically, the control signal is transmitted and received between a control signal transmission/reception unit CTR1 of the terminal 11 and a control signal transmission/reception unit CTR3 of the controller 13, and between a control signal transmission/reception unit CTR2 of the access point 12 and the control signal transmission/reception unit CTR3 of the controller 13.

Each terminal 11 and the access point 12 periodically notify the controller 13 of the packet amounts accumulated in the per-flow buffer units (FB1 and FB2) in units of flows as a control signal via the wireless network 15 #1.

The terminal 11 accumulates packets from each application AP1 in the buffer unit FB1 for each application (for each flow). A packet amount notification unit NTF1 periodically checks the packet accumulation amount of each buffer unit FB1 and notifies the controller 13 of it as a control signal via the control signal transmission/reception unit CTR1.

In addition, the access point 12 accumulates packets from an upper network device 50 in the buffer unit FB2 for each application (for each flow). A packet amount notification unit NTF2 periodically checks the packet accumulation amount of each buffer unit FB2 and notifies the controller 13 of it as a control signal via the control signal transmission/reception unit CTR2.

Further, the per-flow buffer unit FB1 may be owned by the application AP1.

Here, it is assumed that each terminal 11 and the access point 12 notify the controller 13 of the accumulated packet amount at regular cycles t. Each terminal 11 and the access point 12 transmit the same accumulated packet amount notification n times at one cycle (n is an integer equal to or greater than 2). Thus, the time required to transmit the accumulated packet amount notification n times is equal to or less than a cycle t.

The controller 13 records the notified packet accumulation amount and information of the terminals 11, the access point 12, and the per-flow buffers (FB1 and FB2), and determines a transmission timing and a transmission amount (schedule) for each buffer unit based on the above. Then, the controller 13 notifies each terminal 11 and the access point 12 of the schedule as a control signal via the wireless network 15 #1.

The control signal transmission/reception unit CTR3 of the controller 13 receives the control signal from each terminal 11 and the access point 12, and organizes the packet amount accumulated in each of the per-flow buffers (FB1 and FB2) in a database DB.

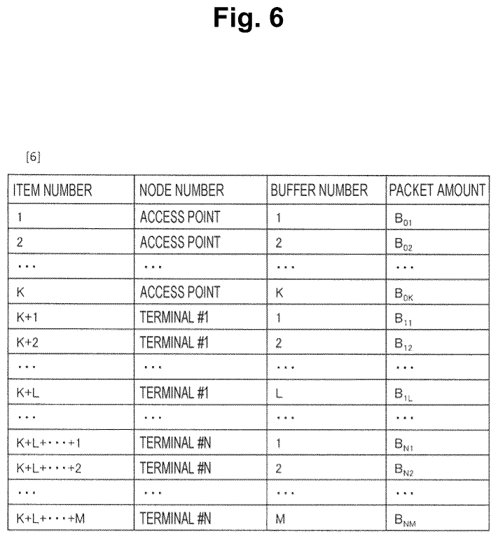

FIG. 6 is a diagram describing an example of information organized in the database DB. This database DB organizes the following three kinds of information.

An item number is a serial number for all of the buffer units (FB1 and FB2) of the terminals 11 and the access point 12.

A node number is a number of the access point 12 or a terminal 11.

A buffer number is a number of the buffer unit FB1 held by each terminal 11 or a number of the buffer unit FB2 held by the access point 12.

A packet amount is a packet accumulation amount held by the buffer unit with its buffer number.

For example, an item number K+2 is a packet accumulation amount of a per-flow buffer unit FB1 #2 held by a terminal 11 #1, meaning that the amount thereof is “B12”.

The scheduling unit SCH3 of the controller 13 determines the transmission timing and the transmission amount for each buffer unit based on the content of the database unit DB using a scheduling method disclosed in Non Patent Literature 3. Then, the scheduling unit SCH3 uses the determined schedule as a control signal and transmits the control signal to the terminal 11 and the access point 12 from the control signal transmission/reception unit CTR3.

Here, it is assumed that the controller 13 notifies each terminal 11 and the access point 12 of the schedule at regular cycles Tc. The controller 13 transmits the same schedule m times (m is an integer equal to or greater than 2). Thus, the time required to transmit the same schedule m times is equal to or less than the cycle Tc.

Each terminal 11 and the access point 12 extract packets accumulated in the per-flow buffer units (FB1 and FB2) at the transmission timing and transmission amount of the notified schedule, and inputs the packets to main signal buffer units (MB1 and MB2). Main signal transmission/reception units (MTR1 and MTR2) transmit packets of the main signal buffer units (MB1 and MB2) to the wireless network 15 #2.

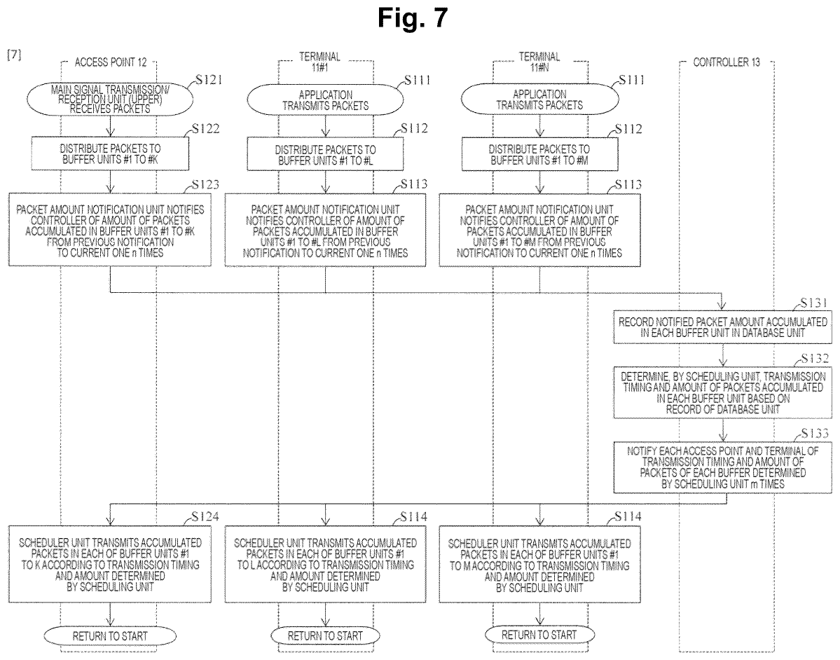

FIG. 7 is a diagram describing the above-described operation in a flowchart. A control method of the present embodiment is a control method for controlling traffic of a wireless network 15 including a terminal 11 and an access point 12 that mutually transmit a packet via the wireless network 15 #2, and a controller 13 that transmits and receives a control signal to and from the terminal 11 and the access point 12 via the wireless network 15 #1, the control method including accumulating transmission packets for each traffic flow in buffer units (FB1 and FB2) of each of the terminal 11 and the access point 12 (steps S111, S112, S121, and S122), transmitting the accumulated packet amount notification, which is the packet amount accumulated in each buffer, having the same content a plurality of times when each of the terminal 11 and the access point 12 transmits the accumulated packet amount notification to the controller as the control signal (steps S113 and S123), recording, by the controller 13, the packet amount from the accumulated packet amount notification and stored in each buffer unit (FB #1 and FB #2) in the database DB unit (step S131), determining, by the controller 13, for each traffic flow, a schedule for transmitting the packet based on the content of the accumulated packet amount notification received from at least one of the terminal 11 and the access point 12 (step S132), transmitting, by the controller 13, the schedule of the same content a plurality of times when transmitting the schedule as the control signal to the terminal 11 and the access point 12 (step S133); and
transmitting, by the terminal 11 and the access point 12, a packet for each traffic flow from each of the buffer units (FB #1 and FB #2) to the wireless network 15 #2 according to the schedule (steps S114 and S124).

### Effects

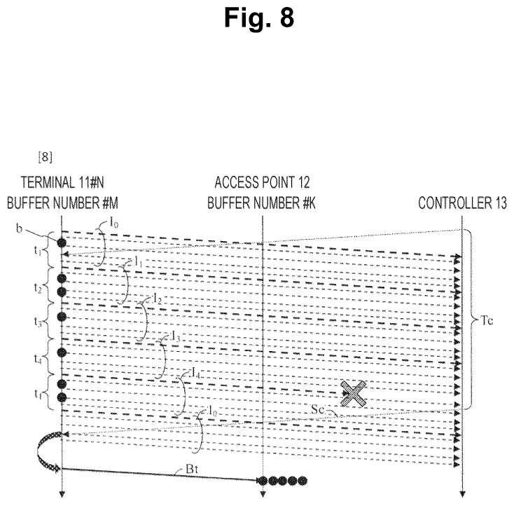

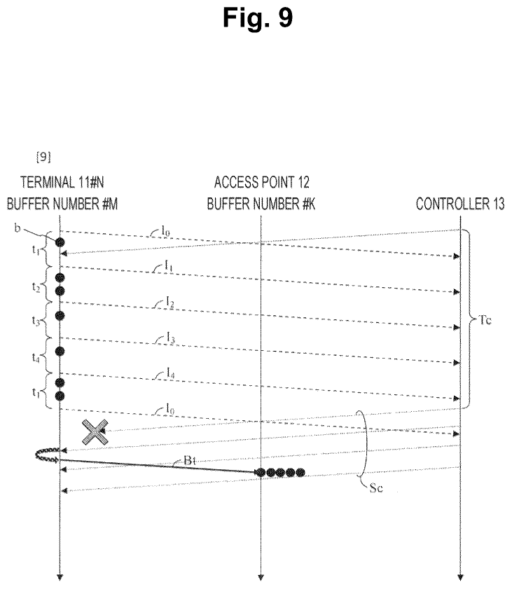

FIG. 8 and FIG. 9 are diagrams describing effects of the communication system 301. The cycle Tc at which the controller 13 performs scheduling and a cycle tᵢ at which the terminal 11 or the access point 12 notifies the controller of the amount of packets accumulated in its own buffer unit (i is an integer equal to or greater than 0) are assumed. FIG. 8 and FIG. 9 describe a case of Tc=5t.

FIG. 8 describes that a terminal 11 #N transmits a packet amount b newly accumulated in a buffer unit FB1 #M held by the terminal 11 #N to the controller as an accumulated packet amount notification Iᵢ in each time tᵢ.

Specifically, the terminal 11 #N transmits information indicating that the packet amount accumulated in the buffer unit FB1 #M is zero in accumulated packet amount notification I₀ (there is no packet in the buffer unit until transmission of I₁), the packet amount is 1 in accumulated packet amount notification I₁ (one packet b is accumulated in the buffer unit #M at a cycle t₁), the packet amount is 3 in accumulated packet amount notification I₂ (two packets b are accumulated in the buffer unit #M at a cycle t₂), the packet amount is 4 in accumulated packet amount notification I₃ (one packet b is accumulated in the buffer unit #M at a cycle t₃), and the packet amount is 5 in accumulated packet amount notification I₄ (one packet b is accumulated in the buffer unit #M at a cycle t₄).

Then, the terminal 11 #N transmits the accumulated packet amount notification Iᵢ n times (n=5 in this example) at each cycle tᵢ.

Here, it is assumed that packet loss occurs during transmission of the accumulated packet amount notification I₄. The accumulated packet amount notification I₄ in which the packet loss has occurred does not reach the controller 13, but the same notification is transmitted n times, and thus the controller 13 can receive any of the notifications. Therefore, the controller 13 can perform scheduling with accurate information.

The controller 13 integrates the accumulated packet amount notification Iᵢ delivered in the period Tc, and recognizes that five packets are accumulated in the buffer unit FB1 #M of the terminal 11 #N. Then, the controller 13 schedules the transmission timing and the transmission time for 5 packets for the buffer unit FB1 #M of the terminal 11 #N. The controller 13 transmits the schedule Sc to the terminal 11 #N.

The terminal 11 #N transmits the five packets from the buffer unit FB1 #M to the access point 12 #K at the timing indicated by the schedule Sc at an indicated speed (step Bt).

Further, although FIG. 8 is a sequence diagram of a case where packets are transmitted from the terminal 11 #N to the access point 12, the same applies when a packet is transmitted from the access point 12 to the terminal 11 #N.

FIG. 9 describes an example in which the controller 13 transmits the schedule to the terminal 11 #N.

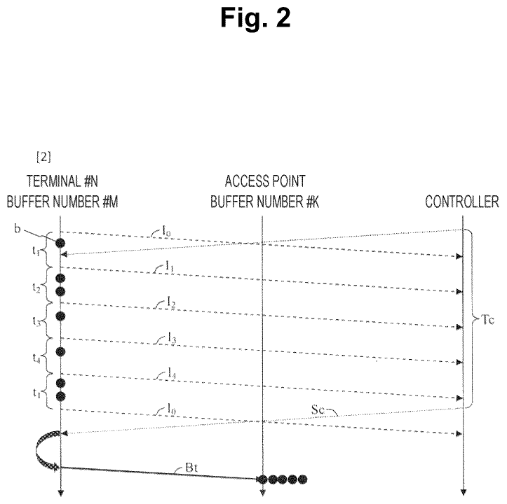

In this example, the operations up to the accumulated packet amount notification I₄ are the same as those described in FIG. 2.

The controller 13 integrates the accumulated packet amount notification Iᵢ delivered in the period Tc, and recognizes that five packets are accumulated in the buffer unit FB1 #M of the terminal 11 #N. Then, the controller 13 schedules the transmission timing and the transmission time for 5 packets for the buffer unit #M of the terminal 11 #N. The controller 13 transmits the schedule Sc to the terminal 11 #N m times (m=4 in this example).

Further, the terminal 11 #N receives the same schedule a plurality of times, and in such a case, the schedule may be updated each time the schedule is received.

In addition, in this drawing, in order to avoid complication of the drawing, description of transmission of the schedule Sc scheduled at the cycle before the cycle Tc is omitted.

Here, it is assumed that packet loss has occurred during transmission of the schedule Sc. Although the schedule Sc in which the packet loss has occurred does not reach the terminal 11 #N, the terminal 11 #N can receive any schedule Sc since the same schedule Sc has been transmitted m times. Therefore, the terminal 11 #N can transmit packets with accurate information (step Bt).

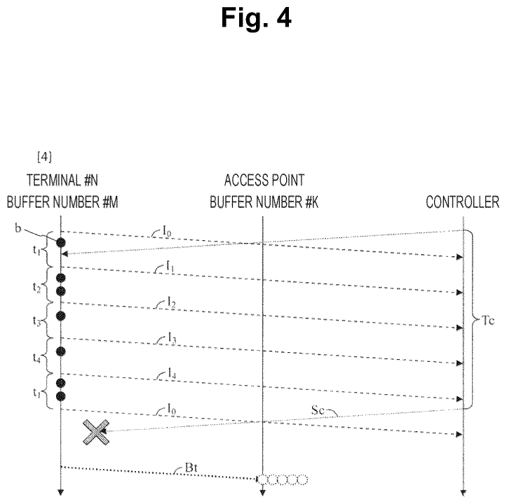

In addition, in the control method described with reference to FIG. 4, when packet loss of the schedule occurs, the packets are transmitted after one cycle Tc (a delay corresponding to the cycle Tc occurs), however, by performing the control method as illustrated in FIG. 9, the packet can be transmitted without waiting for one cycle Tc (the delay can be shortened). Specifically, if the terminal 11 #N can receive the schedule at the mₛ-th time, the delay time is mₛ×Tc/m, and can be made shorter than the delay time Tc of the control method in FIG. 4.

Further, although FIG. 9 is a sequence diagram when packets are transmitted from the terminal to the access point, the same applies when a packet is transmitted from the access point to the terminal.

### Second Embodiment

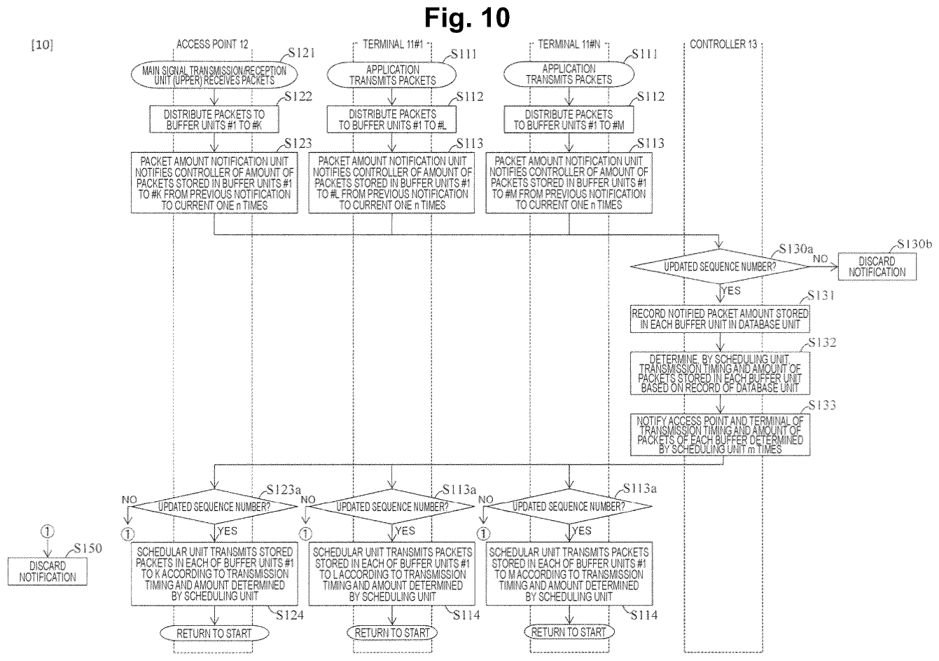

A configuration of a communication system according to the present embodiment is the same as that of FIG. 5. FIG. 10 is a diagram for describing an operation of the communication system of the present embodiment. In the operation of the communication system of the present embodiment, the following step is added to the operation (FIG. 7) of the communication system 301 of the first embodiment.

In the present communication system, a sequence number is assigned to the accumulated packet amount notification and the schedule, the controller 13 discards the accumulated packet amount notification whose sequence number is the same as that of the previous accumulated packet amount notification (Steps S130a and S130b), and the terminal 11 and the access point 12 discard the schedule whose sequence number is the same as that of the previous schedule (steps S113a, S123a, and S150).

When the controller 13 reads the accumulated packet amount notification from each terminal 11 and the access point 12 in a short time, and when each terminal 11 and the access point 12 read the schedule from the controller 13 in a short time, there is concern that a load increases in each device and the quality such as throughput may deteriorate.

Therefore, a sequence number is assigned to the accumulated packet amount notification and the schedule. For example, a sequence number may be embedded in header information of packets of a notification and a schedule.

Each terminal 11, the access point 12, and the controller 13 determine whether it is a notification that the sequence number is updated (accumulated packet amount notification or schedule) (steps S130a, S123a, and S113a). Then, the terminal 11, the access point 12, and the controller 13 read only the updated notification, or the content of the notification (steps S131, S124, and S114) and discard the others (steps S130b and S150).

According to the control method of the present embodiment, even if the accumulated packet amount notification and the schedule are transmitted a plurality of times, degradation of the quality such as throughput can be avoided.

### Third Embodiment

The controller 13 can also be realized by a computer and a program, and the program can be recorded in a recording medium or provided through a network.

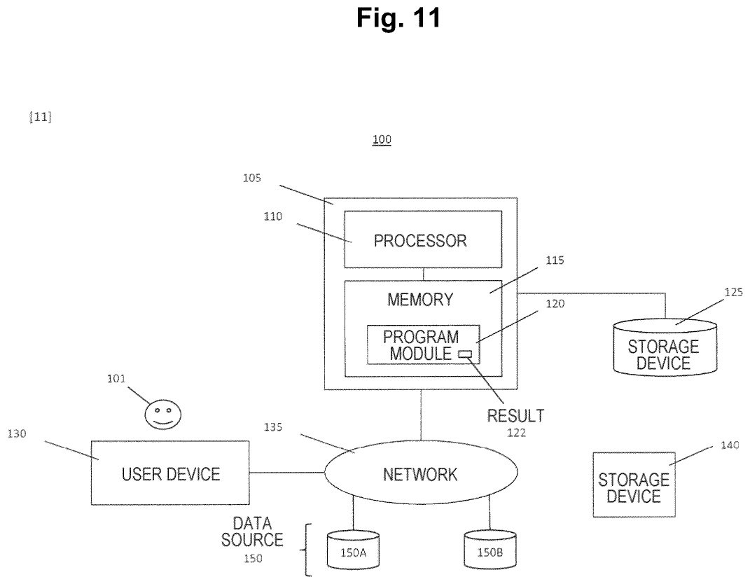

FIG. 11 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area connected across boundaries of cities, rural areas, or countries, and (f) the Internet. Communication is performed by using electronic signals and optical signals via the network 135.

The computer 105 includes a processor 110 and a memory 115 connected to the processor 110. In the present specification, although the computer 105 is represented as a standalone device, the computer is not limited thereto, and may be connected to other devices, which are not illustrate, in a distributed processing system.

The processor 110 is an electronic device including a logic circuitry that responds to a command and executes the command.

The memory 115 is a tangible computer-readable storage medium in which a computer program is encoded. In this regard, the memory 115 stores data and commands, that is, program codes, that are readable and executable by the processor 110 to control operations of the processor 110. The memory 115 can be implemented by a random access memory (RAM), a hard drive, a read-only memory (ROM), or a combination thereof. One of the components of the memory 115 is a program module 120.

The program module 120 includes commands for controlling the processor 110 to perform processes described in the present specification. In the present specification, although it is described that operation is executed by the computer 105, a method, a process, or a sub-process thereof, the operation is actually executed by the processor 110.

In the present specification, the term “module” is used to refer to functional operation that may be embodied as a stand-alone component or as an integrated configuration of a plurality of sub-components. Thus, the program module 120 can be implemented as a single module or as a plurality of modules that operate in cooperation with each other. Further, in the present specification, although the program module 120 is described as being installed in the memory 115 and thus implemented in software, the program module 120 can be implemented in any of hardware (for example, an electronic circuit), firmware, software, or a combination thereof.

Although the program module 120 is illustrated as already being loaded into the memory 115, the program module 120 may be configured to be provided on a storage device 140 so as to be subsequently loaded into the memory 115. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device provided in a remote storage system which is not illustrated and connected to the computer 105 via the network 135.

The system 100 further includes a data source 150A and a data source 150B which are collectively referred to herein as a data source 150 and are communicatively connected to the network 135. In practice, the data source 150 may include any number of data sources, that is, one or more data sources. The data source 150 may include unstructured data and may include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 can provide the output to a storage device 125 such as a database or a memory or to a remote device, which is not illustrated, via the network 135.

For example, a program for performing steps S131 to S133 in the flowchart of FIG. 7 or steps S130 to S133 in the flowchart of FIG. 10 may be used as the program module 120. The system 100 can be operated as the controller 13.

The term “include . . . ” or “including . . . ” specifies that the mentioned features, integers, steps, or components are present, but should be understood as not excluding the presence of one or more other features, complete bodies, steps, or components, or groups thereof. The terms “a” and “an” are indefinite articles and therefore do not exclude embodiments including a plurality of objects.

### Other Embodiments

Further, the present invention is not limited to the above embodiments, and various modifications can be made without departing from the gist of the present invention. In short, the present invention is not limited to the specific embodiments, and in the implementation stage, the components may be modified and embodied without departing from the scope of the present invention.

In addition, various inventions can be made by appropriately combining a plurality of components disclosed in the above embodiments. For example, some components may be deleted from all the components illustrated in the embodiments. Furthermore, components in different embodiments may be appropriately combined.

### REFERENCE SIGNS LIST

11 Terminal
12 Access point
13 Controller
15 Wireless network
50 Upper network device
100 System
101 User
105 Computer
110 Processor
115 Memory
120 Program module
122 Result
125 Storage device
130 User device
135 Network
140 Storage device
150 Data source
301 Communication system

1. A communication system that controls traffic of a wireless network, the communication system comprising:
a terminal and an access point configured to transmit a packet to each other via the wireless network; and
a controller configured to transmit and receive a control signal to and from the terminal and the access point via the wireless network, wherein
each of the terminal and the access point transmits an accumulated packet amount notification that is an amount of packets accumulated in a buffer having the same content a plurality of times when the accumulated packet amount notification is transmitted to the controller as the control signal, and
the controller determines a schedule for transmitting the packet based on the content of the accumulated packet amount notification received from at least one of the terminal and the access point and transmits the schedule having the same content a plurality of times when the schedule is transmitted to each of the terminal and the access point as the control signal.

2. The communication system according to claim 1, wherein
a sequence number is assigned to the accumulated packet amount notification and the schedule,
the controller discards the accumulated packet amount notification whose sequence number is the same as the sequence number of the previous accumulated packet amount notification, and
the terminal and the access point discard the schedule whose sequence number is the same as the sequence number of the previous schedule.

3. A control method for controlling traffic of a wireless network including a terminal and an access point configured to transmit a packet to each other via the wireless network and
a controller configured to transmit and receive a control signal to and from the terminal and the access point via the wireless network, the control method comprising:
transmitting, by each of the terminal and the access point, an accumulated packet amount notification that is an amount of packets accumulated in a buffer having the same content a plurality of times when the accumulated packet amount notification is transmitted to the controller as the control signal; and
determining, by the controller a schedule for transmitting the packet based on the content of the accumulated packet amount notification received from at least one of the terminal and the access point and transmitting the schedule having the same content a plurality of times when the schedule is transmitted to the terminal and the access point as the control signal.

4. The control method according to claim 3, wherein
a sequence number is assigned to the accumulated packet amount notification and the schedule,
the controller discards the accumulated packet amount notification whose sequence number is the same as the sequence number of the previous accumulated packet amount notification, and
the terminal and the access point discard the schedule whose sequence number is the same as the sequence number of the previous schedule.

5. A controller configured to transmit and receive a control signal to and from a terminal and an access point via a wireless network, the terminal and the access point transmitting a packet to each other via the wireless network, the controller comprising:
a reception unit configured to receive, as the control signal, an accumulated packet amount notification that is an amount of packets accumulated in each buffer from at least one of the terminal and the access point;
a scheduling unit configured to determine a schedule for transmitting the packet based on the content of the accumulated packet amount notification; and
a transmission unit configured to transmit the schedule having the same content a plurality of times when the schedule is transmitted to each of the terminal and the access point as the control signal.

6. The controller according to claim 5, wherein
a sequence number is assigned to the accumulated packet amount notification, and
the reception unit discards the accumulated packet amount notification whose sequence number is the same as the sequence number of the previous accumulated packet amount notification.

7. A non-transitory computer-readable medium having computer-executable instructions that, upon execution of the instructions by a processor of a computer, cause the computer to function as the controller according to claim 5.
